(19) United States
(12) Patent Application Publication
(10) Pub. No.: US 2022/0379916 A1
(43) Pub. Date: Dec. 1, 2022

(54) METHOD AND APPARATUS FOR VEHICLE SHARING

(71) Applicant: Nuro, Inc., Mountain View, CA (US)

(72) Inventors: David Ian Ferguson, San Francisco, CA (US); Jiajun Zhu, Palo Alto, CA (US); Cosimo Leipold, Washington, DC (US); Steven Y. Wu, San Mateo, CA (US)

(73) Assignee: Nuro, Inc., Mountain View, CA (US)

(21) Appl. No.: 17/735,973

(22) Filed: May 3, 2022

Related U.S. Application Data
(60) Provisional application No. 63/194,076, filed on May 27, 2021.

(51) Int. Cl. B60W 60/00; B60W 40/08; G08G 1/00; G06Q 50/30

(52) U.S. Cl. CPC B60W 60/005; B60W 60/00253; B60W 40/08; G08G 1/202; G06Q 50/30; B60W 2040/0809; B60W 2540/041; B60W 2540/043

(57) ABSTRACT

According to one aspect, a method includes obtaining a request for a first vehicle from a customer, and dispatching the first vehicle to a first location identified in the request. Dispatching the first vehicle to the first location includes causing the first vehicle to drive in an autonomous mode. The method also includes determining when the first vehicle arrives at the first location, and providing the customer with access to enter the first vehicle.

### PRIORITY CLAIM

This patent application claims the benefit of priority under 35 U.S.C. § 119 to U.S. Provisional Patent Application No. 63/194,076, filed May 27, 2021, and entitled “METHODS AND APPARATUS FOR VEHICLE SHARING,” which is incorporated herein by reference in its entirety.

### TECHNICAL FIELD

The disclosure relates to providing shared vehicles for use by customers. More particularly, the disclosure relates to the delivery, use, and retrieval of shared vehicles which are capable of operating both in an autonomous manner and in a non-autonomous manner.

### BACKGROUND

Vehicle sharing services generally allow a customer to obtain a car or other vehicle for use for a period of time. A customer may reserve a car for use for a period of time, e.g., an hour, or for a duration of a trip, and may specify a location at which the customer will pick up the car and/or return the car.

A car sharing service typically has specific facilities or locations at which cars are stored. When a customer needs to pick up and/or return a shared car, the customer often needs to arrange for transportation to and from a facility at which the shared car is generally housed. Finding transportation to and from a facility at which a shared car is located may be time-consuming and inconvenient for a customer.

### BRIEF DESCRIPTION OF THE DRAWINGS

The disclosure will be readily understood by the following detailed description in conjunction with the accompanying drawings in which:

FIG. 1A is a block diagram representation of an autonomous vehicle fleet which includes passenger vehicles configured to operate either in an autonomous mode or a manual mode in accordance with an embodiment.

FIG. 1B is a block diagram representation of an autonomous vehicle fleet which includes passenger vehicles configured to operate autonomously or manually, e.g., vehicles 101 of FIG. 1A, autonomous occupantless vehicles, and non-autonomous vehicles in accordance with an embodiment.

FIG. 2A is a diagrammatic representation of a passenger vehicle, e.g., passenger vehicle 101 of FIGS. 1A and 1B, which is capable of operating autonomously in accordance with an embodiment.

FIG. 2B is a diagrammatic representation of an autonomous occupantless vehicle, e.g., vehicle 101′ of FIG. 1B, in accordance with an embodiment.

FIG. 3 is a block diagram representation of an autonomous vehicle, e.g., vehicle 101 of FIGS. 1A and 1B, in accordance with an embodiment.

FIG. 4A is a diagrammatic representation of communications associated with a customer procuring a shared vehicle at a time t1 at which the shared vehicle is reserved in accordance with an embodiment.

FIG. 4B is a diagrammatic representation of communications associated with a customer procuring a shared vehicle, e.g., customer 442 and vehicle 401 of FIG. 4A, at a time t2 at which the shared vehicle has arrived at a customer location in accordance with an embodiment.

FIG. 5 is a timeline associated with a customer obtaining a shared vehicle for use in accordance with an embodiment.

FIG. 6 is a timeline associated with a customer returning or relinquishing a shared vehicle in accordance with an embodiment.

FIG. 7 is a process flow diagram which illustrates a method of a customer procuring a shared vehicle in accordance with an embodiment.

FIG. 8 is a process flow diagram which illustrates a method of a customer returning a shared vehicle in accordance with an embodiment.

FIG. 9A is a process flow diagram which illustrates a first method of a customer participating in an authentication process, e.g., step 721 of FIG. 7, in accordance with an embodiment.

FIG. 9B is a process flow diagram which illustrates a second method of a customer participating in an authentication process, e.g., step 721 of FIG. 7, in accordance with an embodiment.

FIG. 10 is a diagrammatic representation of a first framework in accordance with an embodiment.

FIG. 11 is a diagrammatic representation of a second framework in accordance with an embodiment.

FIG. 12A is a process flow diagram which illustrates a method of a customer returning a vehicle that includes determining whether the vehicle is in an unmapped area in accordance with an embodiment.

FIG. 12B is a process flow diagram which illustrates a second method of a customer returning a vehicle that includes determining whether the vehicle is in an unmapped area in accordance with an embodiment.

FIG. 13 is a block diagram representation of an enterprise or fleet management system in accordance with an embodiment.

FIG. 14 is a process flow diagram which illustrates a method of providing a customer with a vehicle which addresses a situation in which the customer is not available at a hand-off location when the vehicle arrives in accordance with an embodiment.

FIGS. 15A-C are a process flow diagram which illustrates a method of providing a customer with a vehicle when the vehicle may not stop at a requested hand-off location in accordance with an embodiment.

FIG. 16 is a process flow diagram which illustrates a method of sensors on a vehicle monitoring the vehicle while the vehicle is in the possession of a customer in accordance with an embodiment.

### DESCRIPTION OF EXAMPLE EMBODIMENTS

### General Overview

According to one aspect, a method includes obtaining a request for a first vehicle from a customer, and dispatching the first vehicle to a first location identified in the request. Dispatching the first vehicle to the first location includes causing the first vehicle to drive in an autonomous mode. The method also includes determining when the first vehicle arrives at the first location, and providing the customer with access to enter the first vehicle. In one embodiment, providing the customer with access include authenticating the customer.

In accordance with another aspect, logic encoded in one or more tangible non-transitory, computer-readable media for execution and, when executed, the logic is operable to obtain a request for a first vehicle from a customer, the request including a first location, and to dispatch the first vehicle to the first location, wherein the logic operable to dispatch the first vehicle to the first location includes logic operable to cause the first vehicle to drive in an autonomous mode. The logic is also operable to provide the customer with access to enter the first vehicle when the first vehicle arrives at the first location, as well as to allow the customer to manually drive the vehicle after the first vehicle arrives at the first location.

According to still another aspect, a platform includes a first vehicle and a fleet management system. The first vehicle includes a vehicle communications system and a switch arrangement, the vehicle communications system configured to enable the vehicle to communicate, the switch arrangement configured to enable the first vehicle to switch between an autonomous mode and a manual mode. The fleet management system includes a fleet communications arrangement configured to enable the fleet management system to communicate with the first vehicle, as well as a control arrangement and a dispatch arrangement. The control arrangement is configured to cooperate with the fleet communications system to control the switch and to cooperate with the dispatch arrangement to cause the first vehicle to drive autonomously to a first location associated with a customer. The control arrangement cooperates with the dispatch arrangement to cause the switch arrangement to switch from the autonomous mode to the manual mode and to provide the customer with access to enter the first vehicle when the first vehicle arrives at the first location. In one embodiment, the switch arrangement is arranged not to switch from the manual mode to the autonomous mode while the customer is provided with access to enter the first vehicle.

A shared vehicle is capable of operating both autonomously and non-autonomously, e.g., manually. When the shared vehicle is requested or otherwise reserved by a customer, the shared vehicle may drive autonomously, or in an autonomous mode, to a location associated with the customer. Upon the customer successfully completing an authentication or verification process, the shared vehicle may be configured in a manual mode and access to the shared vehicle may be provided to the customer. The customer may then enter the shared vehicle and manually drive the shared vehicle. In some instances, the shared vehicle may not be configured to operate in an autonomous mode while the shared vehicle is in the possession of the customer. When the customer has completed his or her use of the shared vehicle, the shared vehicle may be configured in an autonomous mode and autonomously driven to a next location.

### Description

The use of shared vehicles such as cars is increasing. Organizations which engage in car sharing typically maintain fleets of cars, and house the cars in fixed locations. A customer who wishes to use a shared car may travel to one of the fixed locations to retrieve a shared car. When the customer no longer needs to use the shared car, the customer may return to the same fixed location or travel to another fixed location to return the shared car. It may be inconvenient for a customer to travel to and from a fixed location and, as such, the ability for a customer to use a shared vehicle more efficiently may be welcomed by many customers.

By delivering a shared vehicle to a location associated with a customer, the customer may be able to efficiently use the shared vehicle. Further, if the shared vehicle may be returned or relinquished by the customer at the same location, or a different location, associated with the customer, the efficiency with which the customer may use the shared vehicle may be further increased. For example, if a shared vehicle is delivered to a first location at which the customer is at a first time and then picked up from a second location at which the customer is at a second time, the procurement and return of the shared vehicle essentially does not inconvenience the customer.

In one embodiment, a shared vehicle may be a vehicle which is capable of operating both autonomously and manually, or substantially under the control of a human operator in the vehicle. Such a shared vehicle may drive autonomously to and from a customer. The customer may operate the shared vehicle manually, i.e., drive the shared vehicle in a non-autonomous manner, while the shared vehicle is in his or her possession. That is, a shared vehicle may be autonomously delivered to a customer, the customer may take possession of the shared vehicle and drive the shared vehicle manually, and the shared vehicle may be autonomously driven away from the customer when the customer no longer needs the shared vehicle.

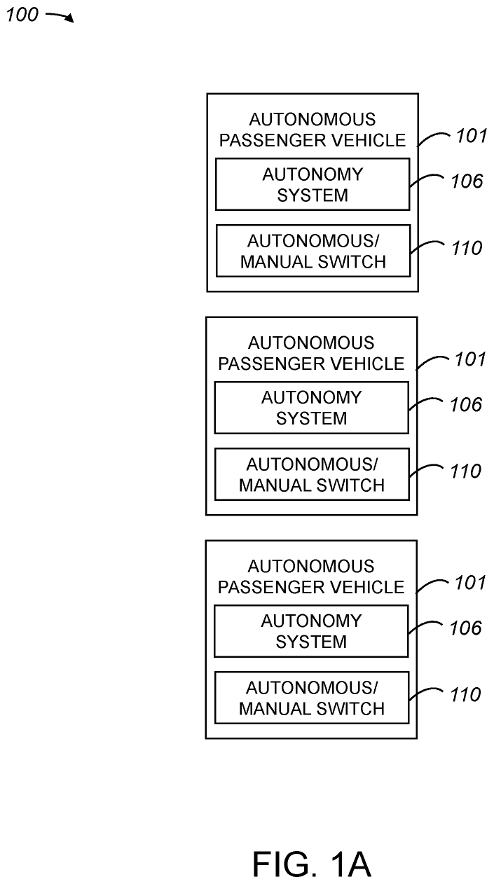

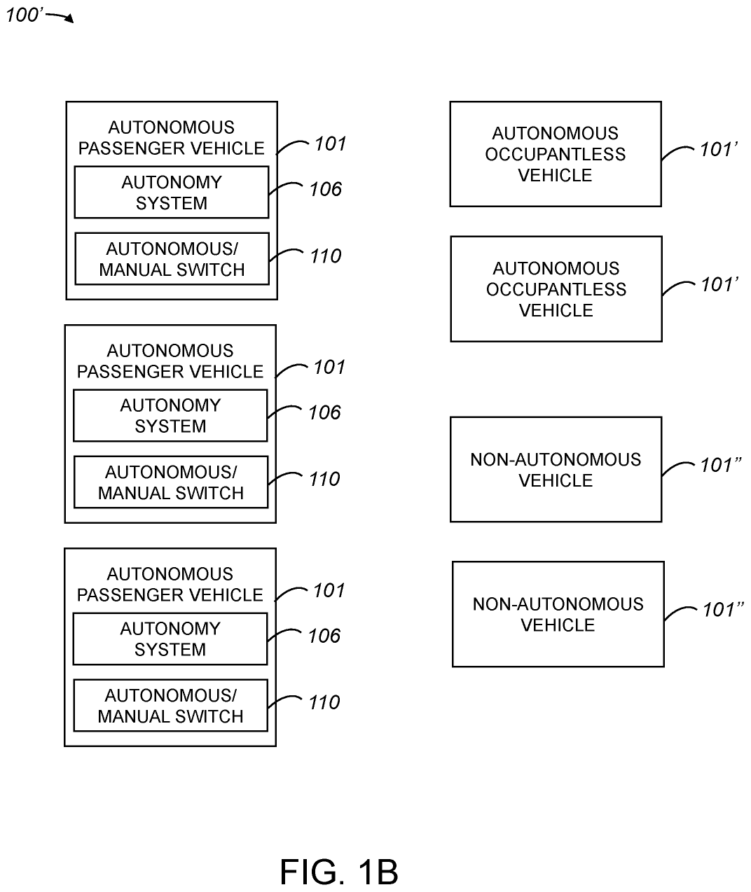

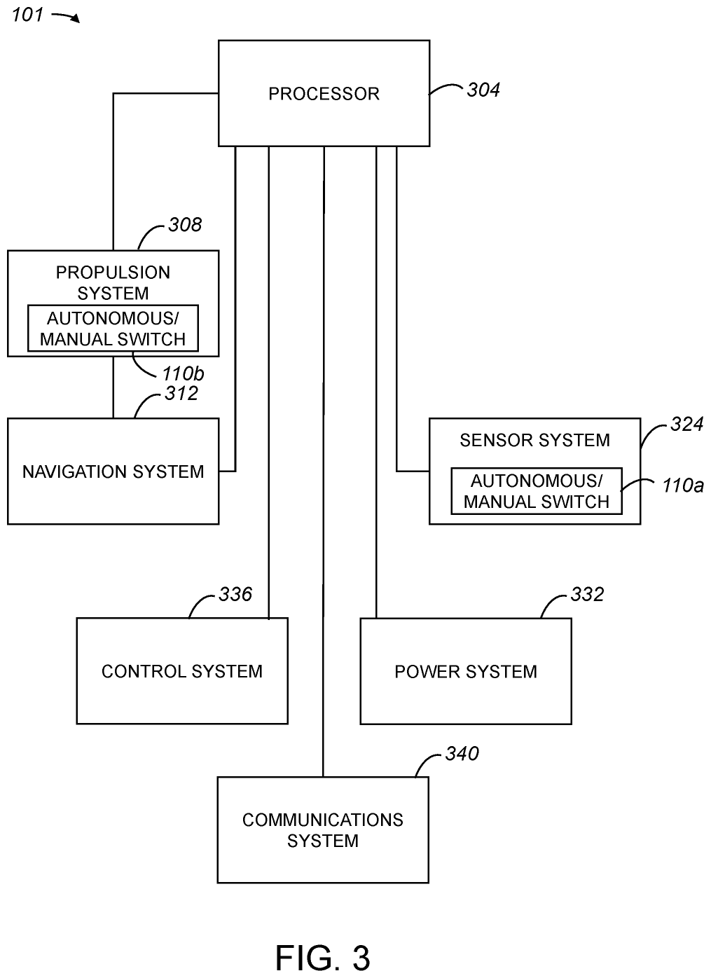

FIG. 1A is a block diagram representation of an autonomous vehicle fleet which includes passenger vehicles configured to operate either in an autonomous mode or a manual mode in accordance with an embodiment. An autonomous vehicle fleet 100 includes a plurality of autonomous passenger vehicles 101 which are configured to drive autonomous or manually. In the described embodiment, autonomous passenger vehicles 101 are generally arranged to transport occupants, e.g., passengers, and may also transport cargo, items, and/or goods. Autonomous passenger vehicles 101 each include an autonomy system 106 which enables autonomous passenger vehicles 101 to operate in a fully autonomous mode and/or semi-autonomous mode. In general, each autonomous passenger vehicle 101 may be a vehicle that is capable of travelling in a controlled manner for a period of time without intervention, e.g., without human intervention. As will be discussed in more detail below with reference to FIG. 3, each autonomous passenger vehicle 101 may include a power system, a propulsion or conveyance system, a navigation module, a control system or controller, a communications system, a processor, and a sensor system.

Each autonomous passenger vehicle 101 also includes a switch arrangement 110 which is configured to enable autonomous passenger vehicle 101 to be switched between operating under the control of autonomy system 106 and operating under the manual control of a driver. Switch arrangement 110 may be a mechanical switch which may be activated by an enterprise (not shown) or a fleet management system (not shown) such that autonomous passenger vehicle 101 either operates autonomously or manually. For example, switch arrangement 110 may include a toggle switch which engages to either place autonomous passenger vehicle 101 in an autonomous mode or in a manual mode. An enterprise may generally be an organization which manages the dispatch of shared vehicles, or leverages a separate dispatcher that manages the dispatch of shared vehicles for use by the enterprise.

Dispatching of autonomous passenger vehicles 101 in autonomous passenger vehicle fleet 100 may be coordinated by an enterprise (not shown) or a fleet management module (not shown) that may dispatch autonomous passenger vehicles 101 for purposes of providing autonomous passenger vehicles 101 to customers such that the customers may manually drive autonomous passenger vehicles 101 for their own purposes.

In one embodiment, a vehicle fleet such as fleet 100 may include vehicles in addition to autonomous vehicles which may either be driven autonomously or manually. FIG. 1B is a block diagram representation of a vehicle fleet which includes passenger vehicles configured to operate autonomously or manually, e.g., vehicles 101 of FIG. 1A, autonomous occupantless vehicles, and non-autonomous vehicles in accordance with an embodiment. Vehicle fleet 100′ includes autonomous passenger vehicles 101, at least one autonomous occupantless vehicle 101′, and at least one non-autonomous vehicle.

Autonomous occupantless vehicles 101′, or robot vehicles, may generally be arranged to transport and/or to deliver cargo, items, and/or goods. Autonomous occupantless vehicles 101′ may be fully autonomous and/or semi-autonomous vehicles. In general, each autonomous occupantless vehicle 101′ may be a vehicle that is capable of travelling in a controlled manner for a period of time without intervention, and may be dispatched for purposes of transporting, delivering, and/or retrieving goods or services in an unstructured open environment or a closed environment.

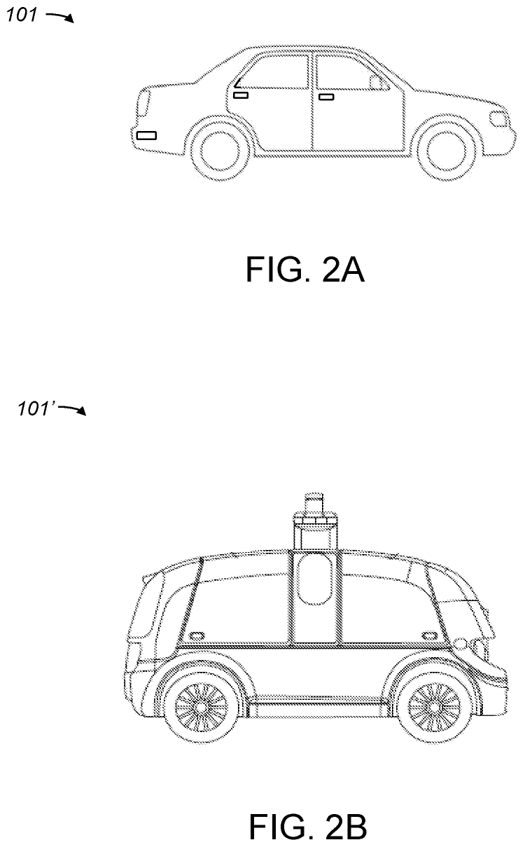

FIG. 2A is a diagrammatic representation of a passenger vehicle, e.g., passenger vehicle 101 of FIGS. 1A and 1B, which is capable of operating autonomously in accordance with an embodiment. Passenger vehicle 101 may be any standard vehicle which may operate under the control of a human driver.

FIG. 2B is a diagrammatic representation of an autonomous occupantless vehicle, e.g., vehicle 101′ of FIG. 1B, in accordance with an embodiment. Autonomous occupantless vehicle 101′, as shown, is a vehicle configured for land travel, and includes compartments suitable for carry goods for delivery. Typically, autonomous occupantless vehicle 101′ includes physical vehicle components such as a body or a chassis, as well as conveyance mechanisms, e.g., wheels. In one embodiment, autonomous occupantless vehicle 101 may be relatively narrow, e.g., approximately two to approximately five feet wide, and may have a relatively low mass and relatively low center of gravity for stability. Autonomous occupantless vehicle 101′ may be arranged to have a working speed or velocity range of between approximately one and approximately forty-five miles per hour (mph), e.g., approximately twenty-five miles per hour. In some embodiments, autonomous occupantless vehicle 101′ may have a substantially maximum speed or velocity in range between approximately thirty and approximately ninety mph.

Referring next to FIG. 3, an autonomous vehicle, e.g., autonomous passenger vehicle 101 of FIGS. 1A and 1B, will be described in accordance with an embodiment. Autonomous passenger vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Propulsion system 308 may be controlled by a driver when autonomous vehicle 101 is operating in a manual mode. In the embodiment as shown, propulsion system 308 includes a component 110b of a switch arrangement, e.g., switch arrangement 110 of FIGS. 1A and 1B, which is configured to enable autonomous vehicle 101 to be switched between operating autonomously and operating under the manual control of a customer or driver, e.g., a customer who is renting autonomous vehicle 101. Component 110b may cause propulsion system 308 to be accessible to, and controlled by, a customer.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment when autonomous vehicle 101 is operating in an autonomous mode.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Sensor system 324 may include sensors which collect information associated with autonomous vehicle 101 itself. For example, sensor system 324 may include cameras configured to film the inside of a cabin of vehicle 101, cameras configured to film the inside of a cargo compartment of vehicle 101, weight sensors configured to determine whether there is someone or something in the cabin, and/or weight sensors configured to determine whether there is something in the cargo compartment. Sensor system 324 may also generally include sensors which may detect a location of vehicle 101 and/or conditions associated with vehicle 101.

In one embodiment, sensor system 324 includes a component 110a of a switch arrangement, e.g., switch arrangement 110 of FIGS. 1A and 1B, which enables autonomous vehicle 101 to switch between operating autonomously and operating under manual control. Component 110a may cause some data from sensor system 324 not to be collected and/or used when autonomous vehicle is operating manually.

Sensor system 324 may include at least one camera which is configured to monitor an interior of autonomous vehicle 101. Such a camera may enable a driver of autonomous vehicle 101, i.e., a customer who is using autonomous vehicle 101, to be monitored. Monitoring the driver may enable an enterprise or a fleet management system to ascertain whether the driver is able to safely operate autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel when autonomous vehicle 101 is operating autonomously, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system such as autonomy system 106 of FIGS. 1A and 1B. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

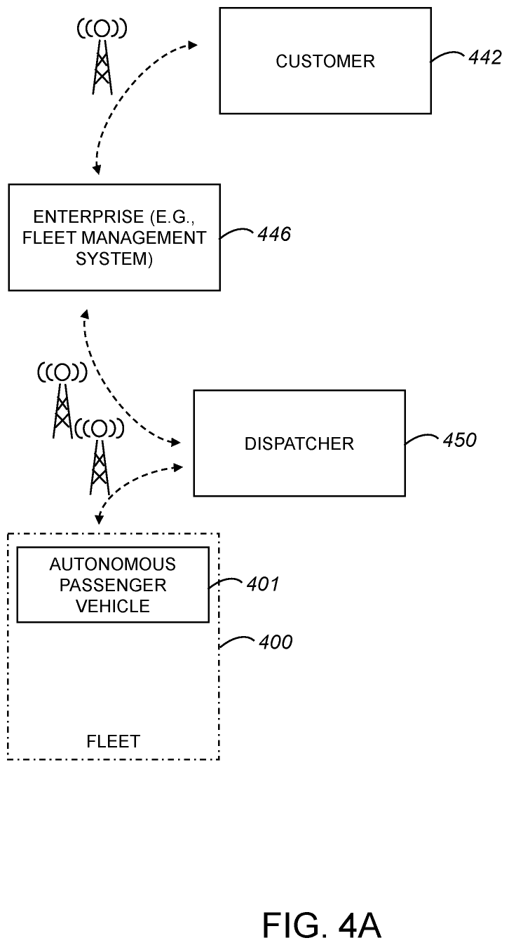

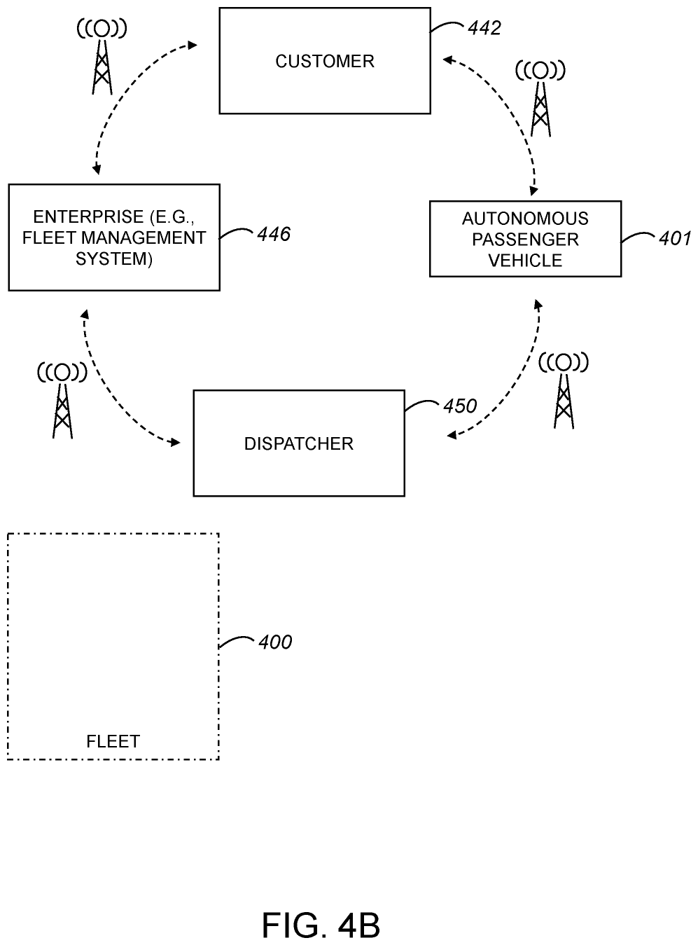

When a customer requests the use of a shared vehicle, as for example through the use of a car sharing application, the fulfillment of the request typically involves communications between various systems. FIG. 4A is a diagrammatic representation of communications associated with a customer procuring a shared vehicle at a time t1 at which the shared vehicle is reserved in accordance with an embodiment. At a time t1, a customer 442 may communicate with an enterprise 446 to request the use of a shared vehicle. Customer 442 may communicate with enterprise 446, or a fleet management system, using cellular or network communications such as LTE and/or 3G/4G/5G communications.

In one embodiment, upon obtaining a request for a shared vehicle, enterprise 446 may communicate with a dispatcher 450, and dispatcher 450 may communicate with at least one autonomous passenger vehicle 401 in a vehicle fleet 400. Dispatcher 450 may dispatch autonomous passenger vehicle 401 based on the request from customer 442. Once dispatched, autonomous passenger vehicle 401 may drive autonomously to a location associated with customer 442.

At a time t2, vehicle 401 arrives at a location associated with customer 442. FIG. 4B is a diagrammatic representation of communications associated with customer 442 procuring vehicle 401 at a time t2 at which vehicle 401 has arrived at the location associated with customer 442 in accordance with an embodiment. At time t2, customer 442 is able to interact substantially directly with autonomous passenger vehicle 401, e.g., to gain access to autonomous passenger vehicle 401. Communications between customer 442 or, more specifically, a device in the control of customer 442, may include, but are not limited to including, cellular communications, Bluetooth communications, wireless network communications such as Wi-Fi communications, LTE communications, and/or 3G/4G/5G communications. Customer 442 may also continue to communicate with enterprise 446. Communications between customer 442 and either or both enterprise 446 and autonomous passenger vehicle 401 may enable customer 442 to be authenticated and, hence, effectively be granted permission to enter autonomous passenger vehicle 401 and to manually drive autonomous passenger vehicle 401.

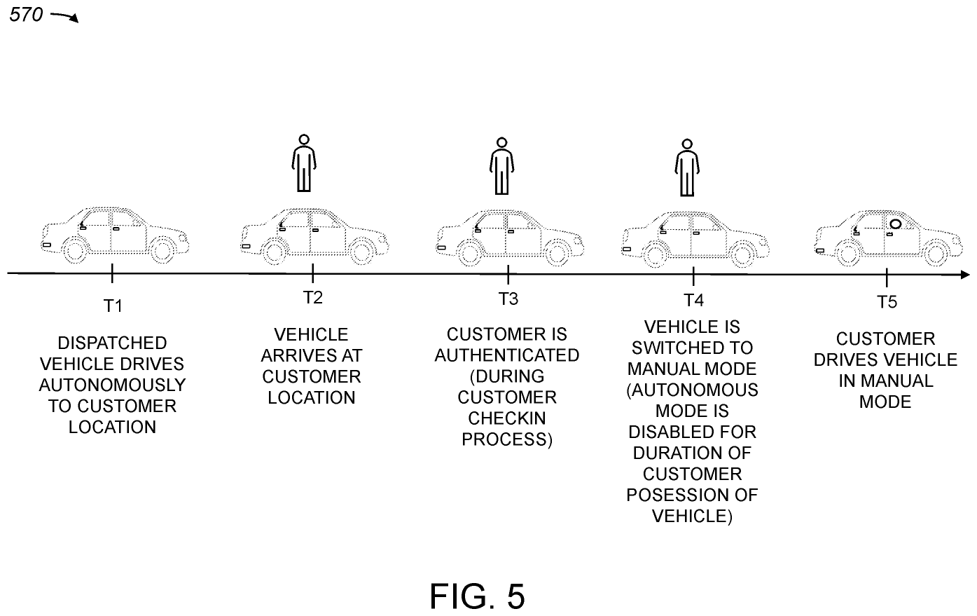

As previously mentioned, a shared vehicle may operate autonomously when in transit to and from a customer, and then may be configured to operate substantially only in a non-autonomous mode, e.g., a manual mode, when driven by the customer. FIG. 5 is a timeline associated with a customer obtaining a shared vehicle for use in accordance with an embodiment. As shown in a timeline 570, at a time T1, a shared vehicle that is dispatched to a customer drives autonomously to a location associated with the customer. That is, the vehicle operates under the control of an autonomy system when it is dispatched to a customer by an enterprise or a dispatcher.

At a time T2, the vehicle arrives at the location associated with the customer. At a time T3, the customer is authenticated. Authenticating the customer may involve communications between the customer and the vehicle, communications between the customer and an enterprise, or both. In general, an authentication process may be part of an overall checkin process during which the customer may confirm a reservation for the vehicle, indicate where the customer plans to drive the vehicle, indicate a length of time associated with the reservation, and/or accept conditions associated with his or her possession of the vehicle. After the customer is authenticated, the vehicle is switched to a manual mode at a time T4, e.g., by the enterprise. That is, the enterprise may configure the vehicle to stop operating autonomously, and to start operating under manually under the control of the customer. In one embodiment, the vehicle is effectively prevented from operating autonomously, or switching into an autonomous mode, while the vehicle is in the possession of the customer. Once the vehicle is configured to enable the customer to manually drive the vehicle, the customer drives the vehicle in a manual mode at a time T5.

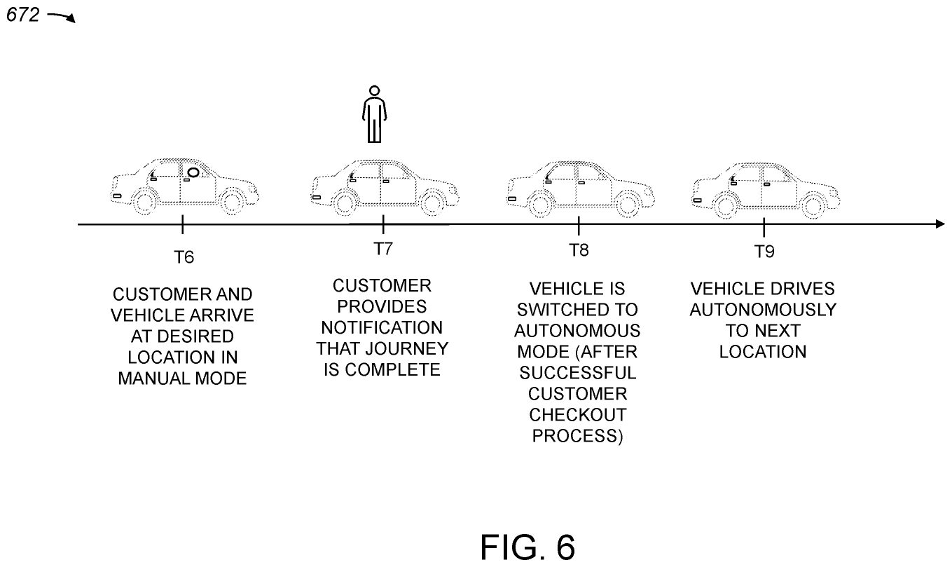

FIG. 6 is a timeline associated with a customer returning or relinquishing a shared vehicle in accordance with an embodiment. As shown in a timeline 672, at a time T6, a customer who is manually driving a shared vehicle arrives at his or her desired location. That is, the customer arrives at his or her intended location and has completed use of the shared vehicle. At a time T7, the customer provides a notification that his or her journey is complete. Such a notification may be provided directly by the customer to an enterprise, or may be provided by the customer to the enterprise through the vehicle. Further, such a notification may be substantially automatically provided when, for example, a customer has been determined to no longer be present inside the vehicle. As part of providing a notification that a journey is complete, the customer may engage in a checkout process which may enable the customer to confirm that particular conditions have been met and/or that he or she is relinquishing the vehicle.

At a time T8, the vehicle is switched to an autonomous mode by the enterprise. It should be appreciated that the vehicle may be switched to an autonomous mode at the conclusion of a successful customer checkout process. Then, at a time T9, the vehicle drives in autonomous mode to a next location. The next location may be a location associated with another customer, or a location at which the vehicle is to be housed or maintained.

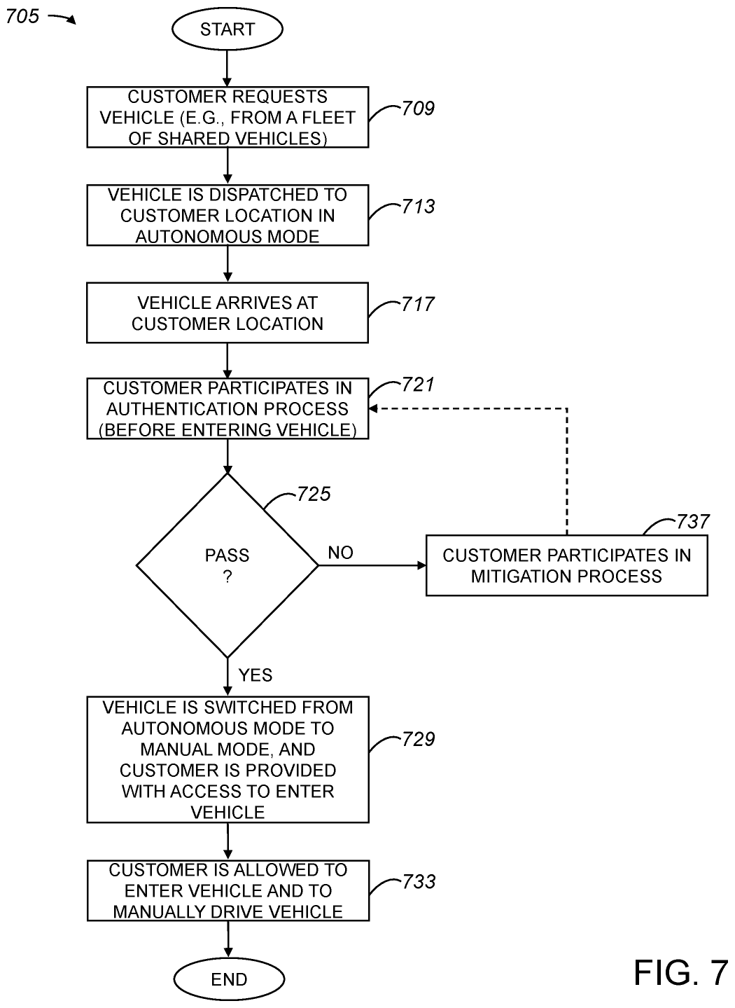

Referring next to FIG. 7, a method of a customer procuring a shared vehicle will be described in accordance with an embodiment. A method 705 of procuring a shared vehicle begins at a step 709 in which a customer requests a shared vehicle. The shared vehicle may be part of a fleet or pool of shared vehicles, and a customer request may generally be a request to reserve a shared vehicle for use. The customer may request a shared via using a variety of different methods including, but not limited to including, making a reservation using a web application, a web site, and/or an application running on a portable mobile device such as a smartphone. The request may specify a location at which the customer would like the vehicle to effectively be delivered or otherwise provided. In one embodiment, an enterprise may determine whether the location specified by the customer is reachable by a vehicle, e.g., whether the location includes unmapped regions which the vehicle may not be able to navigate autonomously, and the enterprise may suggest alternate locations to the customer as appropriate.

Once the customer requests a vehicle, an enterprise and/or a dispatcher may dispatch a vehicle to a location associated with the customer in a step 713. The vehicle drives autonomously to the location associated with the customer, and arrives at the location in a step 717.

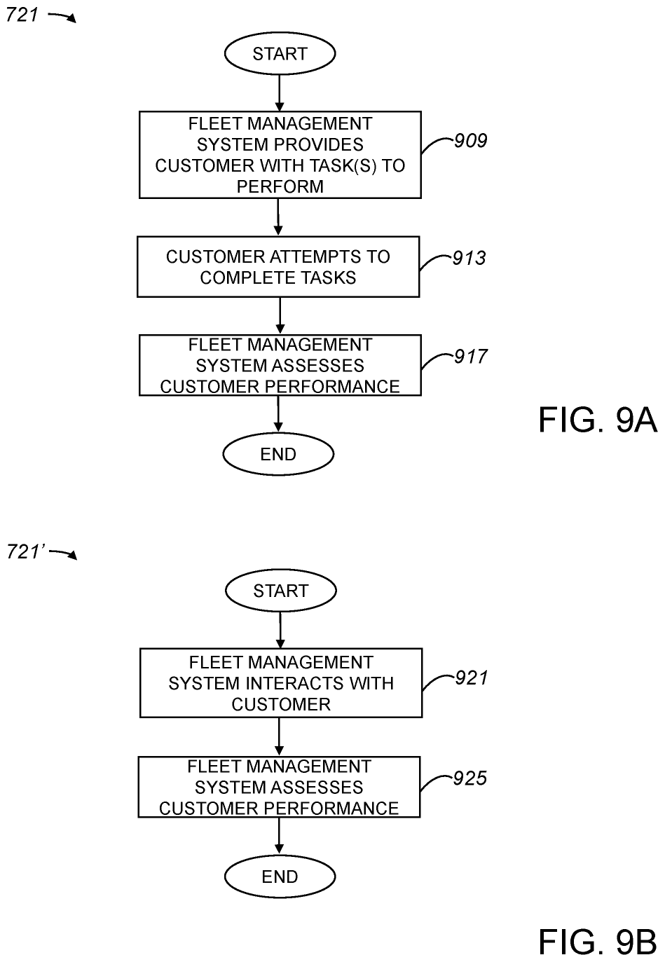

Upon arrival of the vehicle at the location associated with the customer, the customer participates in an authentication process in a step 721. Typically, the authentication process enables a determination to be made, as for example by an enterprise, as to whether the customer is who he or she purports to be. Such a determination may also include determining whether the customer is in condition to operate the vehicle, e.g., whether the customer is impaired. Methods of enabling a customer to participate in an authentication process will be discussed below with reference to FIGS. 9A and 9B. The authentication may be performed prior to providing the customer with access to the vehicle, e.g., before the customer enters the vehicle to physically occupy the vehicle.

In a step 725, a determination is made as to whether the customer has successfully completed the authentication process. In other words, it is determined whether the customer is to be provided with access to the vehicle.

If the determination in step 725 is that the customer has passed the authentication process, then process flow proceeds to a step 729 in which the vehicle is switched from autonomous mode to manual mode, and the customer is provided with access to the vehicle. In one embodiment, an enterprise may send signals to the vehicle to cause the vehicle to be switched to manual mode and to remain in manual mode until the customer relinquishes the vehicle and/or completes his or her use of the vehicle. While the customer is in possession of the vehicle, the vehicle generally may not operate in an autonomous mode. Providing the customer with access to the vehicle may include, but is not limited to including, unlocking the vehicle and/or providing the customer with a code to enter to gain access to the vehicle. It should be appreciated that the code provided to the customer may be used by the customer each time he or she wishes to enter the vehicle to drive the vehicle, or the code may be used by the customer to enter the vehicle a first time to find a physical key stored in the vehicle which may be used to unlock the vehicle and to start the vehicle.

After the customer is provided with access to the vehicle, the customer enters the vehicle and manually drives the vehicle in a step 733. Manually driving the vehicle generally includes controlling the vehicle, e.g., steering the vehicle and varying the speed at which the vehicle travels. Once the customer manually drives the vehicle, the method of procuring a shared vehicle is completed.

Returning to step 725, if the determination is that the customer has not passed the authentication process, the indication is that the customer is not to be provided with access to the vehicle. Accordingly, process flow moves from step 725 to a step 737 in which the customer participates in a mitigation process. Participating in a mitigation process may include the customer interacting with an enterprise, as for example using a smartphone, to determine whether the customer may be provided with another opportunity to be authenticated. The mitigation process may result in the customer not gaining access to the vehicle. However, in the embodiment as shown, after the mitigation process, process flow returns to step 721 in which the customer participates in another authentication process.

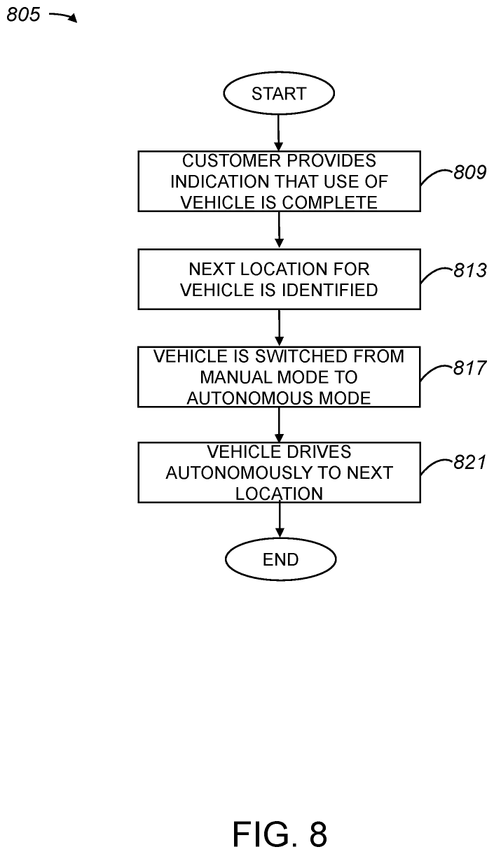

FIG. 8 is a process flow diagram which illustrates a method of a customer returning or relinquishing a shared vehicle in accordance with an embodiment. A method 805 of returning a vehicle begins at a step 809 in which the customer provides an enterprise with an indication that his or her use of the vehicle is complete. The indication may be a request to return the vehicle, e.g., a return request, or a request to relinquish the vehicle. In one embodiment, the indication may be the arrival of the vehicle at a predetermined location and/or a determination that the customer is no longer present in the vehicle. After the customer provides an indication that his or her use of the vehicle is complete, process flow moves to a step 813 in which the enterprise identifies a next location to which the vehicle is to travel.

In a step 817, the enterprise causes the vehicle to switch from manual mode to autonomous mode. It should be appreciated that such a switch may be triggered substantially only after the customer has alighted from the vehicle. Once the vehicle is switched to autonomous mode, the vehicle drives autonomously to the next location in a step 821, and the process of returning a shared vehicle is completed.

With reference to FIGS. 9A and 9B, methods of authenticating a customer with respect to a shared vehicle with be described. FIG. 9A is a process flow diagram which illustrates a first method of a customer participating in an authentication process, e.g., step 721 of FIG. 7, in accordance with an embodiment. Method 721 of a customer participating in an authentication process begins at a step 909 in which an enterprise, or a fleet management system, provides the customer with one or more tasks to perform. The tasks may include, but are not limited to including, entering an access code or password as for example into an application on a smartphone and/or providing personal information to confirm an identify of the customer.

After the tasks are provided, the customer attempts to complete the tasks in a step 913. Then, in a step 917, the enterprise or fleet management system assesses the performance of the customer, and the method of a customer participating in an authentication process is completed.

FIG. 9B is a process flow diagram which illustrates a second method of a customer participating in an authentication process, e.g., step 721 of FIG. 7, in accordance with an embodiment. Method 721′ of a customer participating in an authentication process begins at a step 921 in which an enterprise, or a fleet management system, interacts with the customer. Interacting with the customer may include, but is not limited to including, the fleet management system providing questions which the customer attempts to answer, e.g., using an application on a smartphone. In one embodiment, interacting with the customer may include, but is not limited to including, obtaining data from the customer which may indicate whether the customer is impaired, e.g., intoxicated or under the influence of drugs. A breathalyzer test using a device accessible on a shared vehicle may be part of an interaction. In addition, a customer service agent may engage in a live chat, using a smartphone of the customer, to assess whether the customer is impaired. In a step 917, the enterprise or fleet management system assesses the performance of the customer with respect to the interactions, and the method of a customer participating in an authentication process is completed.

As mentioned above, an enterprise may be an organization or a company which facilitates the deployment of shared vehicles. The enterprise may be part of a framework that effectively use the services of dispatchers, or organizations which are separate from the enterprise but essentially provide customers of the enterprise with shared vehicles. Alternatively, the enterprise may be part of a framework in which the enterprise itself provides customers with shared vehicles.

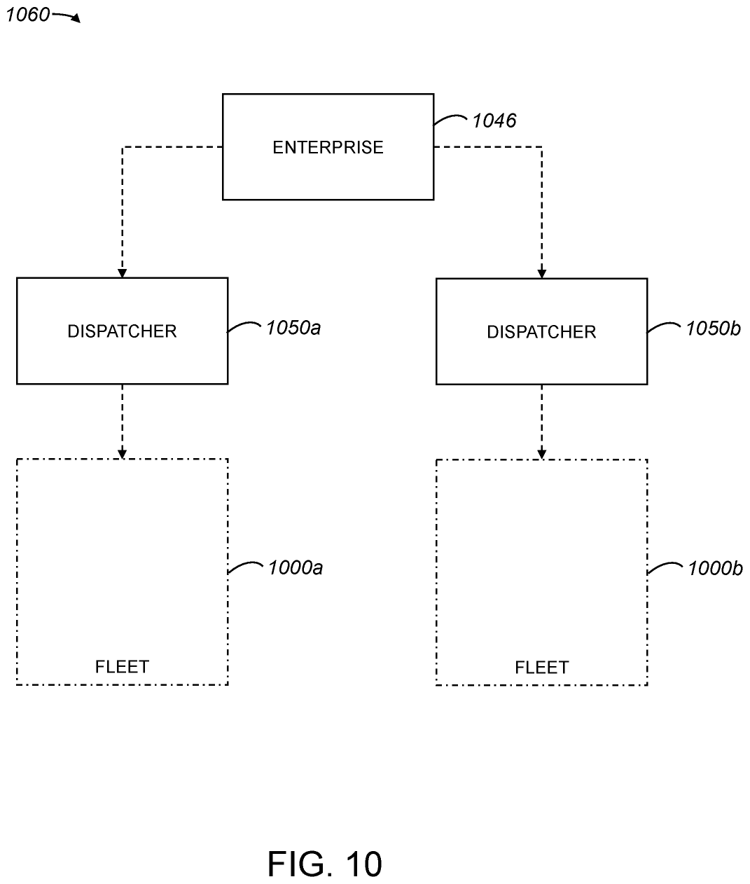

FIG. 10 is a diagrammatic representation of a first framework in accordance with an embodiment. A framework 1060 includes an enterprise 1046 and plurality of dispatchers 1050a, 1050b. Enterprise 1046 is generally arranged to service customers who request the use of shared vehicles. Dispatchers 1050a, 1050b are generally arranged to manage the deployment of shared vehicles. Dispatcher 1050a manages a fleet 1000a of vehicles, and dispatcher 1050b manages a fleet 1000b of vehicles. At least one of fleets 1000a, 1000b may include one or more shared vehicles that are configured to drive both autonomously and non-autonomously. It should be appreciated that while two dispatchers 1050a, 1050b are shown, the number of dispatchers 1050a, 1050b may vary widely.

Enterprise 1046 may have customers who request the use of a shared vehicle. When enterprise 1046 obtains a request for a shared vehicle, enterprise 1046 may notify dispatchers 1050a, 1050b. In response to the request, one of dispatchers 1050a, 1050b may dispatch a vehicle from one of fleets 1000a, 1000b, respectively, to autonomously drive to a location associated with a customer.

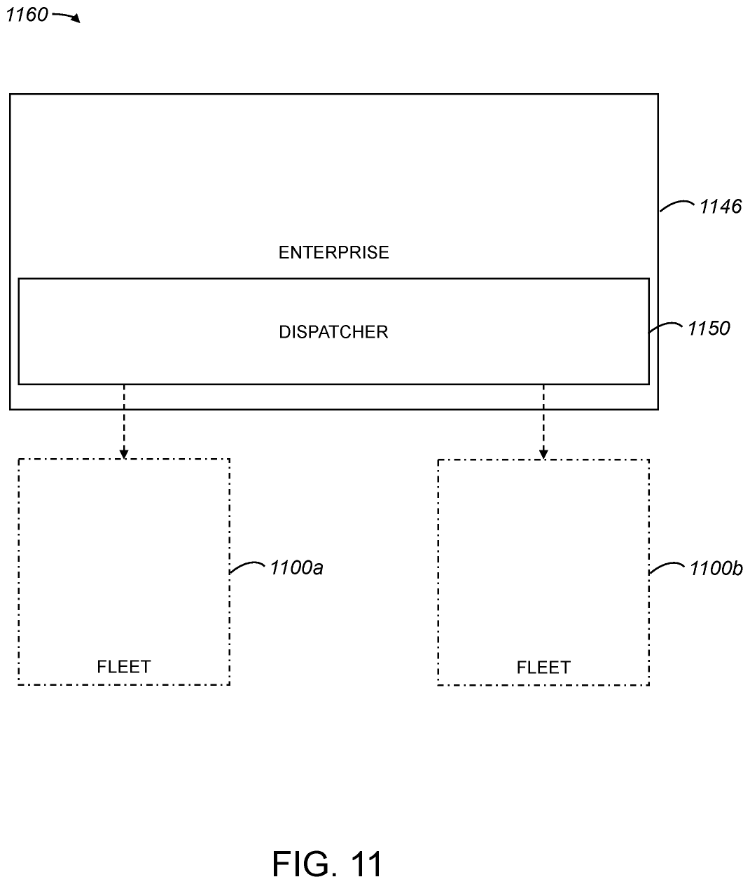

FIG. 11 is a diagrammatic representation of a second framework in accordance with an embodiment. A framework 1160 includes an enterprise 1146. Enterprise 1146 includes a dispatcher 1150, and generally provides service customers who request the use of shared vehicles. Dispatcher 1150 manages manage the deployment of shared vehicles from one or more fleets 1100a, 1100b of vehicles. At least one of fleets 1100a, 1100b may include one or more shared vehicles that are configured to drive both autonomously and non-autonomously.

In some situations, a shared vehicle may be manually driven by a customer to a location which is not conducive to the autonomous operation of the shared vehicle. For example, if the customer drives the shared vehicle to an unmapped area such as a private road or a parking lot, an autonomy system on the shared vehicle may be unable to drive the vehicle. When a customer attempts to return or relinquish a shared vehicle at an unmapped location, the customer may be prompted to drive the shared vehicle to a nearby mapped location such that the shared vehicle may be able to autonomously drive from the nearby mapped location to the next location to which the shared vehicle is to be dispatched.

Additionally, in other situations, a shared vehicle may not be able to autonomously drive in or through a mapped location that is not part of an operational design domain of the shared vehicle. By way of example, a mapped road may be such that the shared vehicle is not allowed to drive on the road in an autonomous mode. Some mapped locations may have speed limits or other conditions that are not within the operational design domain of the shared vehicle and, thus, the shared vehicle may not be allowed to drive autonomously in or through those mapped locations. Such mapped locations may effectively be considered to be unallowed or substantially inaccessible locations when the shared vehicle is unable to drive on an otherwise mapped road due to particular constraints.

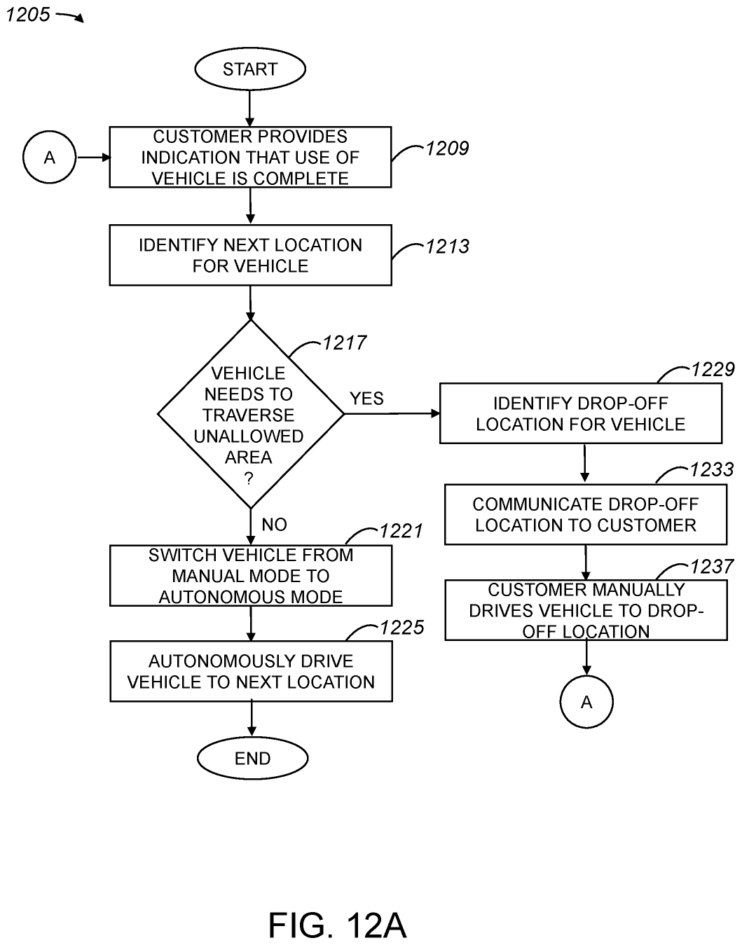

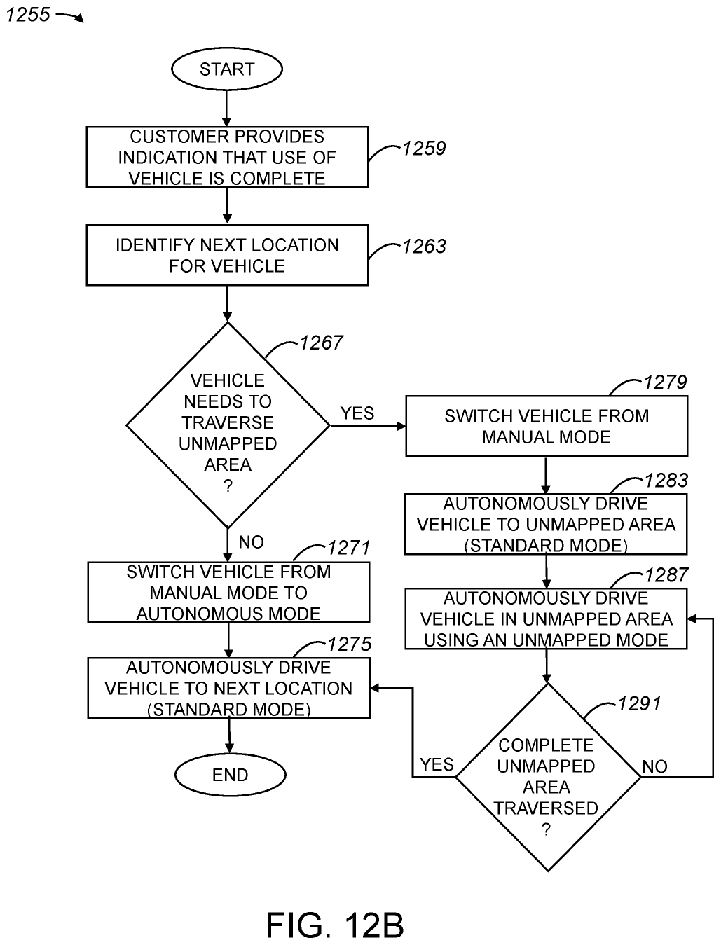

In one embodiment, when a shared vehicle is unable to drive through a substantially unallowed area in an autonomous mode, a customer of the shared vehicle may be asked to manually drive the shared vehicle to a mapped area. FIG. 12A is a process flow diagram which illustrates a first method of a customer returning a vehicle that includes determining whether the vehicle is in an unmapped area in accordance with an embodiment. A method 1205 of a customer returning a vehicle begins at step 1209 in which a customer provides an enterprise with an indication that his or her use of a shared vehicle is complete. Upon obtaining such a notification from the customer, the enterprise identifies a next location for the vehicle in a step 1213. The enterprise may identify a next location by determining whether there is a new request that is to be fulfilled by the vehicle and, if there is a new request associated with the vehicle, identifying a location associated with the new request. The next location may also be a location at which the vehicle is to be housed until there is another request that the vehicle may service.

Once the next location is identified, a determination is made in a step 1217 as to whether the vehicle needs to traverse an unallowed area in order to drive from a current location of the vehicle to the next location. The unallowed area may be an unmapped area or a mapped area that is outside of the operational design domain of an autonomy system associated with the vehicle. Such a determination may often include determining whether the vehicle is currently in an unmapped area such as a private road or a parking lot.

If it is determined in step 1217 is that the vehicle does not need to traverse an unmapped area, then in a step 1221, the enterprise causes the vehicle to switch from manual mode to autonomous mode. After the vehicle is switched to autonomous mode, the vehicle autonomously drives to the next location in a step 1225, and the method of the customer returning a vehicle is completed.

Returning to step 1217, if the determination is that the vehicle needs to traverse an unallowed area such as unmapped area, the implication is that the vehicle may be unable to safely drive in autonomous mode in the unallowed area. Accordingly, process flow proceeds to a step 1229 in which the enterprise identifies an appropriate drop-off location for the vehicle. Identifying an appropriate drop-off location may include, but is not limited to including identifying a nearest mapped area at which the vehicle may be parked, identifying a set of nearby mapped areas at which the vehicle may be parked, identifying a nearest mapped area that is within an operational design domain of the autonomy system of the vehicle at which the vehicle may be parked, and/or identifying a set of nearby mapped areas within the operational design domain of the autonomy system of the vehicle at which the vehicle may be parked.

In a step 1233, the one or more drop-off locations are communicated to the customer. The communication to the customer may occur by sending a notification, e.g., a message in an application associated with the enterprise or a text, from the enterprise to the customer. Once the customer receives information about one or more drop-off locations, the customer may manually drive the vehicle to a suitable drop-off location. After the customer arrives at the suitable drop-off location, process flow returns to step 1209 in which the customer provides an indication that his or her use of the vehicle is complete.

When a shared vehicle is to be driven autonomously from a drop-off location to a next location, and a route between the drop-off location and the next location includes an area that has not been mapped, the shared vehicle may be driven autonomously but with precautions. For example, the shared vehicle may be driven autonomously through a substantially unmapped area at a lower speed. In one embodiment, the shared vehicle may collect information while driving autonomously through the substantially unmapped area, and the gathered information may effectively allow the substantially unmapped area to be mapped. FIG. 12B is a process flow diagram which illustrates a second method of a customer returning a vehicle that includes determining whether the vehicle is in an unmapped area in accordance with an embodiment. A method 1255 of a customer returning a vehicle begins at step 1259 in which a customer provides an enterprise with an indication that his or her use of a shared vehicle is complete. After obtaining such a notification from the customer, the enterprise identifies a next location for the vehicle in a step 1263. The next location may be a location of a new customer, or the next location may be a location at which the vehicle may be inspected or serviced.

Once the next location is identified, a determination is made in a step 1267 as to whether the vehicle will follow a route that traverses an unmapped area in order to drive from a current location of the vehicle to the next location. Such a determination may include, but is not limited to including, determining whether the vehicle is currently in an unmapped area such as a private road or a parking lot.

If it is determined in step 1267 is that the vehicle will not traverse an unmapped area, then in a step 1271, the enterprise causes the vehicle to switch from manual mode to autonomous mode. After the vehicle is switched to autonomous mode, the vehicle autonomously drives to the next location in a step 1275. In one embodiment, the vehicle may autonomously drive in a substantially standard mode, as for example following road rules including, but not limited to including, speed limits. When an area is mapped, the vehicle may drive in a substantially standard mode. When an area is unmapped, the vehicle may drive in a non-standard mode, e.g., slower than the vehicle may drive in a comparable mapped area, such that the vehicle essentially exercises extra caution. The method of the customer returning a vehicle is completed once the vehicle drives to the next location in a substantially standard mode.

Returning to step 1267, if it is determined that the vehicle will traverse an unmapped area, the implication is that the vehicle is unable drive autonomously in a standard in the unmapped area. Accordingly, process flow proceeds to a step 1279 in which the vehicle is effectively switched from a manual mode to an autonomous mode. In a step 1283, the vehicle autonomously drives from the vehicle to the unmapped area in a standard mode.

Upon reaching the unmapped area, the vehicle may drive in or through the unmapped area in an “unmapped” mode in a step 1287. In one embodiment, an unmapped or non-standard mode may involve the vehicle driving at a relatively low speed because the vehicle is in an area that is not adequately mapped. While the vehicle drives in an unmapped mode, the vehicle may collect information that may be used for mapping purposes. That is, the vehicle may map surroundings while driving in the unmapped mode.

A determination is made in a step 1291 as to whether the unmapped area has been traversed. If it is determined that the unmapped area has been traversed, then process flow proceeds to step 1275 in which the vehicle autonomously drives to the next location. Alternatively, if it is determined in step 1291 that the unmapped area has not been traversed, the indication is that there is effectively still more of the unmapped area to traverse. As such, process flow returns to step 1287 in which the vehicle continues to drive in an unmapped mode.

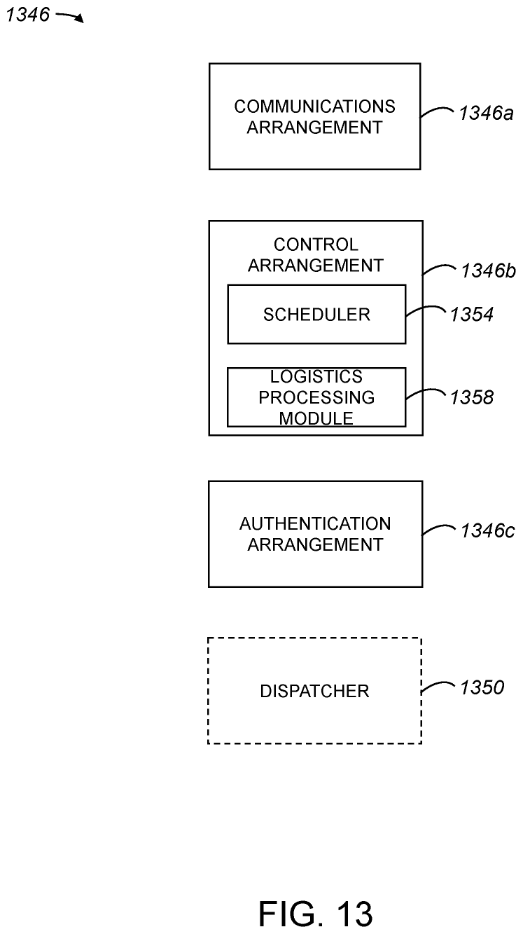

An enterprise or fleet management system, e.g., enterprise 446 of FIGS. 4A and 4B, may generally be configured to manage a fleet of vehicles and to communicate as appropriate to facilitate the deployment of a vehicle to a customer. With reference to FIG. 13, an enterprise or fleet management system will be described in accordance with an embodiment. In general, an enterprise or fleet management system 1346 may perform functions including, but not limited to including pre-positioning vehicles based on forecasted demand, may enable vehicles to be monitored such that issues may be identified, and may enable the placement and deployment of vehicles to account for factors such as the time of day and the amount of battery power available for the vehicle. Enterprise or fleet management system 1346 may be a substantially standalone system or node, or may be distributed across multiple nodes in a network. Enterprise 1346 includes a communications arrangement 1346a, a control arrangement 1346b, an authentication arrangement 1346c. and an optional dispatcher or dispatch arrangement 1350. Communications arrangement 1346a, control arrangement 1346b, authentication arrangement 1346c. and optional dispatcher or dispatch arrangement 1350 may include hardware and/or software logic arranged to be executed by a processor.

Communications arrangement 1346a enables enterprise 1346 to communicate with vehicles, customers, and/or dispatchers, e.g., dispatchers which are not part of communications arrangement 1346a. The communications supported by communications arrangement 1346a may generally include, but are not limited to including, wireless communications supported by a cellular network, a 3G/4G/5G network, an LTE networks, and/or a Wi-Fi network.

Control arrangement 1346b is generally configured to process requests or reservations for a vehicle. In one embodiment, control arrangement 1346b may include a scheduler 1354 arranged to schedule vehicles in a fleet to fulfill requests or reservations such that the use of vehicles may be efficient and substantially optimized. Control arrangement 1346b includes a logistics processing module 1358 which may identify a suitable vehicle to fulfill a request or a reservation. Logistics processing module 1358 may also define behaviors which may be undertaken by a vehicle in response to particular conditions. For example, logistics processing module 1358 may be arranged to monitor the behavior of a vehicle in the possession of a user to determine whether the vehicle is in need of a charge or fuel fill-up, and/or may be arranged to specify a remedial action to be taken by the vehicle when the vehicle is driving autonomously and is unable to complete a vehicle hand-off to a customer at a predetermined hand-off location. Control arrangement 1346b is also configured to cooperate with communications arrangement 1346a to communicate or otherwise send instructions to a vehicle, and to receive information from the vehicle.

Authentication arrangement 1346c is configured to authenticate and/or to authorize a customer to access a particular vehicle, e.g., a vehicle assigned by control arrangement 1346b to fulfill a request or a reservation from the customer. Authentication arrangement 1346c may process information obtained from the customer, as for example through information obtained from the customer through communications arrangement 1346a, to effectively verify the identity of the customer and to determine whether to grant the customer access to a vehicle.

Optional dispatcher 1350 is configured to cooperate with communications arrangement 1346a to dispatch a vehicle to a customer, e.g., based on a request from customer. It should be appreciated that dispatcher 1350 is optional because a dispatcher or functionality associated with a dispatcher may be separate from enterprise 1346 but in communication with enterprise 1346 through communications arrangement 1346a.

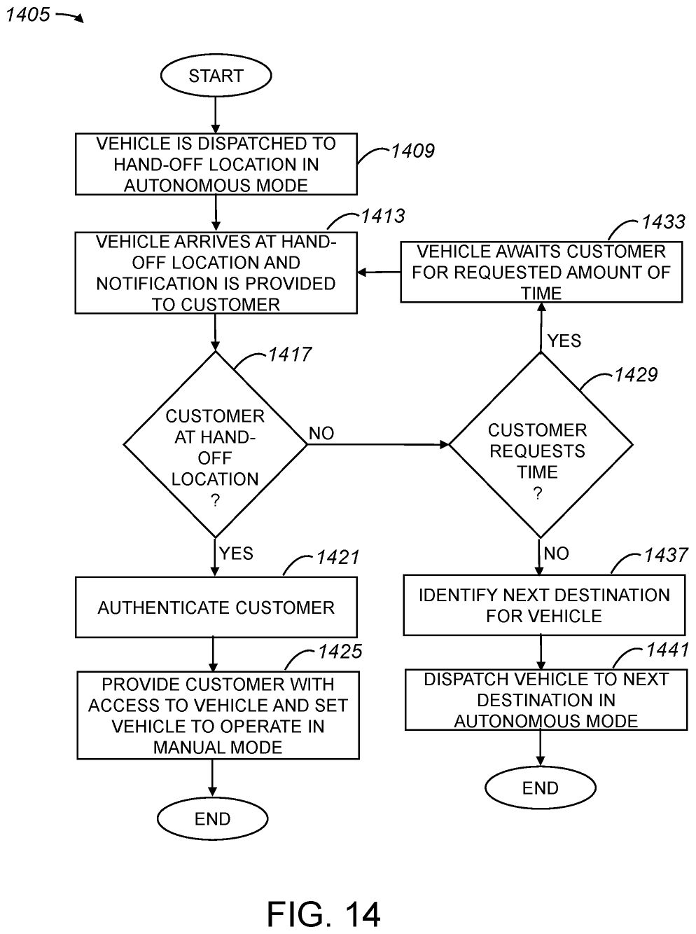

In general, when a vehicle is dispatched autonomously to a hand-off location at which the vehicle is to be handed off to a customer, the vehicle may autonomously drive to the hand-off location, come to a safe stop at or near the hand-off location, and allow the customer access. While a customer may already be at a hand-off location to effectively receive a vehicle, situations may arise in which the customer is unable to meet the vehicle at the hand-off location at a predetermined time and/or when the vehicle arrives at the hand-off location. By way of example, a customer who orders a vehicle to meet him or her at an airport may be delayed due to a flight delay, baggage issues, etc. FIG. 14 is a process flow diagram which illustrates a method of providing a customer with a vehicle which addresses a situation in which the customer is not available at a hand-off location when the vehicle arrives in accordance with an embodiment.

A method 1405 of providing a customer with a vehicle begins at a step 1409 in which a vehicle is dispatched to a hand-off location in an autonomous mode. In a step 1413, the vehicle arrives at the hand-off location and a notification is provided to the customer. The notification may be provided by the vehicle, or by a fleet management system, upon arrival of the vehicle at the hand-off location. The format of the notification may vary widely and may include, but is not limited to including, a text message, a phone call, and/or an email message.

A determination is made in a step 1417 as to whether the customer is physically present at the hand-off location. Such a determination may be made based upon tracking the location of the customer through an electronic device such as a cell phone, and/or through information provided by the customer, as for example in response to the notification.

If the determination in step 1417 is that the customer is at the hand-off location, then the implication is that the customer is available to take possession of the vehicle. Accordingly, process flow proceeds to a step 1421 in which the customer is authenticated. In one embodiment, the customer may communicate with a fleet management system as part of an authentication process.

After the customer is authenticated, the customer is provided with access to the vehicle in a step 1425, and the vehicle is effectively set to operate in manual mode, e.g., under the control of the customer. The customer may be provided with access to the vehicle through a password or a pin that the customer may used to unlock and to control the vehicle. In one embodiment, the password may be entered into a human machine interface (HMI) on the vehicle. In another embodiment, the password may be entered into an application on a cell phone that unlocks the vehicle. Setting the vehicle to operate in manual mode may include, for example, substantially preventing the vehicle from being switched from the manual mode to an autonomous mode while the customer has access to the vehicle. The method of providing a customer with access to a vehicle is completed upon the customer gaining access to the vehicle and the vehicle being set to operate in manual mode.

Returning to step 1417 and the determination of whether the customer is at the hand-off location, if it is determined that the customer is not at the hand-off location, a determination is made in a step 1429 as to whether the customer has requested additional time to reach the hand-off location. If the determination is that the customer has requested more time, then in a step 1433 the vehicle awaits the customer for the requested amount of time. It should be appreciated that if the vehicle is unable to remain at the hand-off location for the requested amount of time, the vehicle may leave the hand-off location, e.g., to drive in a loop or to park in a different location, and return to the hand-off location after the requested amount of time has substantially elapsed. From step 1433, process flow returns to step 1413 in which a notification is provided to the customer that the vehicle is at the hand-off location.

Alternatively, if it is determined in step 1429 that the customer has not requested more time, the indication is that the customer either does not want the vehicle or is otherwise unable to use the vehicle. As such, in a step 1437, a next destination for the vehicle is identified. The next destination may be a depot at which a fleet of vehicle is stored, or the next destination may be a location associated with another customer. Once the next destination is identified, the vehicle is dispatched in a step 1441 to the next destination in autonomous mode, and the method of providing a customer with access to a vehicle is completed.

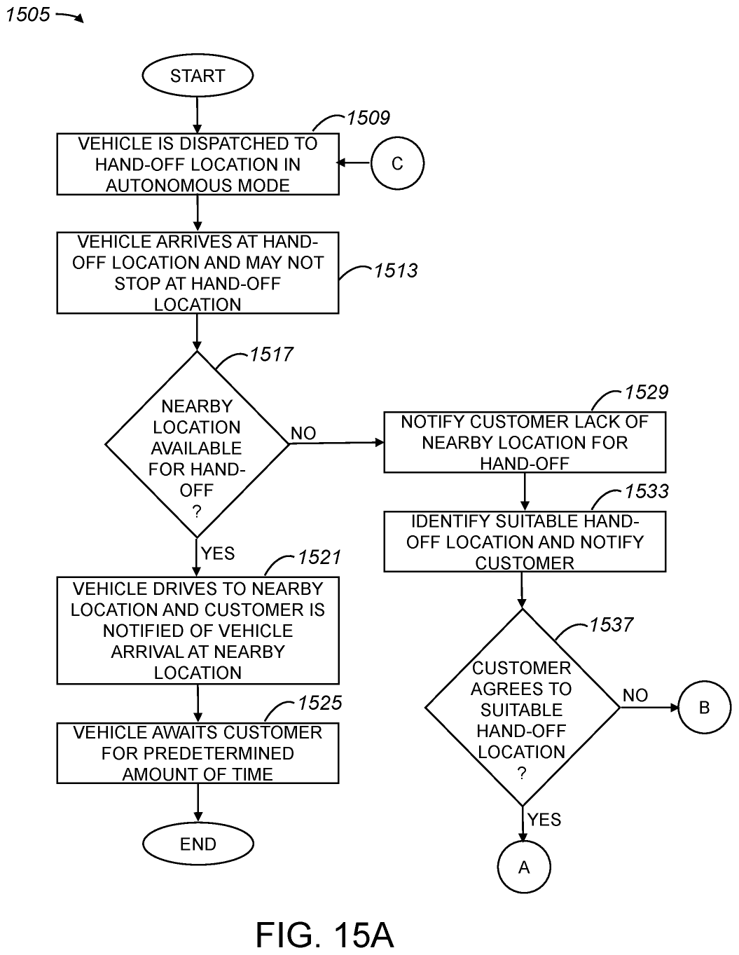

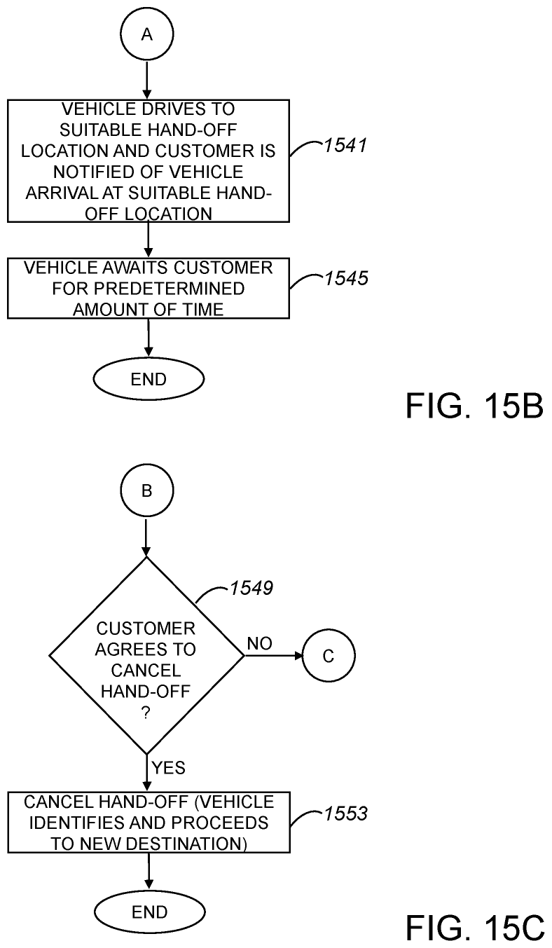

There may be situations which may not be conducive to a customer taking possession of a vehicle. For example, a vehicle may be unable to park at or near a hand-off location. With reference to FIGS. 15A-C, a method of providing a customer with a vehicle when the vehicle may not stop at a requested hand-off location will be described in accordance with an embodiment. A method 1505 of providing a customer with a vehicle when the vehicle may not stop at an identified hand-off location begins at a step 1509 in which the vehicle is dispatched, in an autonomous mode, to the identified hand-off location. In a step 1513, the vehicle arrives at the hand-off location, and determined that the vehicle is effectively unable to stop at the hand-off location. By way of example, the vehicle may be unable to stop if there are no available parking spaces or if there is a security gate at the hand-off location that the vehicle is unable to navigate.

A determination is made in a step 1517 as to whether there is a nearby location that is available for a hand-off. If it is determined that a nearby location is available for a hand-off, then the vehicle drives to the nearby location in a step 1521, and the customer is notified of the arrival of the vehicle at the nearby location. The nearby location may be a location that is within a threshold distance away from the hand-off location. It should be appreciated that the customer may specify, as for example at the time of requesting the vehicle, a substantially maximum distance he or she is willing to travel away from the hand-off location. After the customer is notified of the arrival of the vehicle at the nearby location, the vehicle awaits the arrival of the customer for a predetermined amount of time in a step 1525, and the method of providing a customer with a vehicle when the vehicle may not stop at an identified hand-off location is completed.

Alternatively, if it is determined in step 1517 that there is no nearby location available for a hand-off, then process flow proceeds to a step 1529 in which the customer is notified of the lack of a nearby location for a hand-off. A suitable hand-off location is then identified in a step 1533, and the customer is notified of the suitable hand-off location, The suitable hand-off location may be the nearest location to the original hand-off location at which a hand-off may be completed.

In a step 1537, it is determined whether the customer has agreed to a hand-off of the vehicle at the suitable hand-off location. If it is determined that the customer has agreed to a hand-off of the vehicle at the suitable hand-off location, then in a step 1541, the vehicle drives autonomously to the suitable hand-off location and the customer is notified of the arrival of the vehicle at the suitable hand-off location. In a step 1545, the vehicle awaits the customer for a predetermined amount of time, and the method of providing a customer with a vehicle when the vehicle may not stop at an identified hand-off location is completed.

Returning to step 1537, if the customer does not agree to a hand-off of the vehicle at the suitable hand-off location, then process flow proceeds to a step 1549 in which a determination is made as to whether the customer has agreed to cancel a hand-off of the vehicle. If it is determined that the customer has agreed to cancel the hand-off, the hand-off is cancelled in a step 1553. Cancelling the hand-off may include identifying a new destination for the vehicle. The method of providing a customer with a vehicle when the vehicle may not stop at an identified hand-off location is completed upon cancelling the hand-off.

Alternatively, the determination in step 1549 is that the customer has not agreed to cancel the hand-off, the vehicle may once again attempt to hand-off the vehicle at the original hand-off location. Accordingly, process flow proceeds from step 1549 to step 1509 in which the vehicle is effectively re-dispatched to the original hand-off location.

As previously mentioned, a vehicle may include sensors which are configured to determine a current location of the vehicle and/or a condition of the vehicle. Sensors used to facilitate the autonomous operation of the vehicle may also be used in the context of the manual operation of the vehicle by providing information relating to the use of the vehicle by the customer, e.g., providing information to an enterprise or fleet management system. In one embodiment, an overall sensor system on the vehicle may monitor the vehicle at substantially all times while the customer is driving the vehicle or in possession of the vehicle.

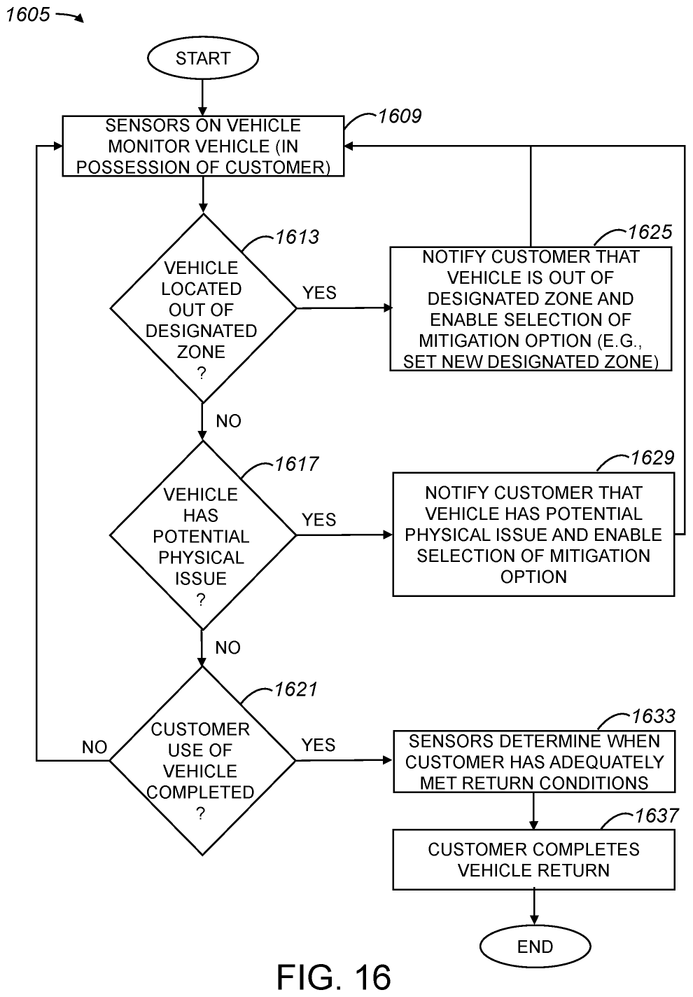

FIG. 16 is a process flow diagram which illustrates a method of sensors on a vehicle monitoring the vehicle while the vehicle is in the possession of the customer in accordance with an embodiment. A method 1605 begins at a step 1609 in which sensors on the vehicle effectively monitor the vehicle. The sensors may monitor an exterior of the vehicle, an interior of the vehicle, and/or an environment around the vehicle. The sensors may monitor the vehicle while the vehicle is in a manual mode, while a customer is manually driving the vehicle, and/or while the vehicle is in the possession of the customer.

It is determined in a step 1613 whether the vehicle is located out of a designated zone. In one embodiment, when a customer takes possession of a vehicle, the customer may effectively agree to drive the vehicle substantially only within a predetermined area or designated zone. When the vehicle is determined to be outside of the designated zone, or close to an edge of the designated zone, sensors on the vehicle may cause the customer to be alerted that the vehicle is either out of or about to be out of the designated zone.

When it is determined in step 1613 that the vehicle is not located out of the designated zone, a determination is made in a step 1617 as to whether the vehicle has a potential physical issue. For example, sensors may identify an issue such as a battery which is close to drained or a fuel level that is near empty.

If the determination in step 1617 is that the vehicle does not have a potential physical issue, then in a step 1621, it is determined whether the customer has indicated that his or her use of the vehicle is complete. That is, a determination is made as to whether the customer has initiated a process of returning or relinquishing the vehicle. If the customer has not indicated that his or her use of the vehicle is complete, process flow returns to step 1609 in which the sensors continue to monitor the vehicle.

Alternatively, if it is determined in step 1621 that the customer use of the vehicle is completed, sensors determine in a step 1633 when the customer has adequately met return conditions. In one embodiment, sensors may be used to effectively inspect the vehicle to ascertain whether the vehicle is in a suitable state to be returned. For example, sensors may determine whether there is damage to the vehicle, whether there are any items left either in a cabin or a compartment of the vehicle, whether the amount of electrical charge or fuel in the vehicle is adequate, and/or whether the vehicle is in an appropriate drop-off location. Sensors may monitor movements and actions taken by a customer to meet return conditions. Once the return conditions are met, the customer completes the return of the vehicle, and the method of monitoring the vehicle is completed

Returning to step 1617 and the determination of whether the vehicle has a potential physical issue, if it is determined that there is a potential physical issued, the customer is notified of the potential physical issue in a step 1629. The customer is also provided with one or more mitigation options. By way of example, if the physical issue relates to a need to charge a battery on the vehicle, a mitigation option may involve identifying charge stations that are in the vicinity of the vehicle. After the customer is notified of the potential physical issue and is allowed to select a mitigation option, process flow returns to step 1609 in which the sensors on the vehicle continue to monitor the vehicle.

Referring back to step 1613, if the determination is that the vehicle is either located out of a designated zone or near a border of the designated zone, then in a step 1625, the customer is notified about the location of the vehicle and allowed to select a mitigation option in a step 1625. The type of mitigation options presented to the customer may vary widely but may include, but are not limited to including, allowing the customer to modify the designated zone and substantially commit to paying any additional fees incurred by an expanded designated zone. Additional fees may be incurred, for example, if the vehicle may not be able to drive autonomously out of the modified designated zone. After the customer is notified that the vehicle is out of the designated zone and a mitigation option is selected, process flow returns to step 1609 in which the sensors on the vehicle continue to monitor the vehicle.

Although only a few embodiments have been described in this disclosure, it should be understood that the disclosure may be embodied in many other specific forms without departing from the spirit or the scope of the present disclosure. By way of example, while the reservation or rental of shared vehicles has generally been described, the methods associated with autonomously delivering a vehicle to a customer, enabling the customer to operate the vehicle manually, and then retrieving the vehicle from the customer by autonomously driving the vehicle away from the customer is not limited to being associated with the reservation or rental of shared vehicles. The methods described in the disclosure may be applicable to the rental of vehicles from car rental agencies, truck rental agencies, and the like.

In one embodiment, when a shared vehicle is operating autonomously and a situation arises in which the performance of an autonomy system may be below desired standards, the shared vehicle may be placed under the control of a teleoperator. For instance, if a shared vehicle that is operating autonomously encounters a significant obstacle as the shared vehicle is driving to a location associated with a customer, a teleoperations system may be used to take control of the shared vehicle to navigate around the significant obstacle.

A teleoperations system may facilitate the delivery of a vehicle to a customer. That is, in lieu of a vehicle driving autonomously to a hand-off location, the vehicle may be driven to the hand-off location by a teleoperator. Similarly, when a customer completes the use of a vehicle, the vehicle may be retrieved from a drop-off location by a teleoperator.

A framework which supports the deployment of shared vehicles has generally ben described as including an enterprise which manages one or more dispatchers, or an enterprise which includes a dispatcher. It should be understood that a framework may include an enterprise which includes a dispatcher and manages one or more dispatchers without departing from the spirit or the scope of the present disclosure.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner. While an autonomous vehicle may be an electric vehicle, it should be appreciated that an autonomous vehicle is not limited to being an electric vehicle. For example, the autonomous vehicle may be powered by any suitable energy for fuel source including, but not limited to including, gasoline, diesel, and/or fuel cells such as hydrogen.

An enterprise or fleet management system, as for example as described above with respect to FIG. 13, may perform smart processing. Smart processing may enable an enterprise to allocate resources based on predicted demand. Smart processing may also enable an enterprise to allocate resources based on other factors including, but not limited to including, accounting for external factors such as weather and events in an area, predicting a percentage of no-shows for reserved vehicles, and load-balancing to substantially optimize revenue and/or serviceability.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. By way of example, a method of monitoring a vehicle may include providing a customer with a grace period after a vehicle return is completed during which the customer may access a cabin or a compartment of the vehicle. In addition, when a vehicle arrives at a customer location, e.g., step 717 of FIG. 7, the vehicle may determine whether there is a need to proceed to an unmapped area such as a driveway at the customer location and, if so, the vehicle may switch to operating in a non-standard mode that accounts for driving in an unmapped area. Therefore, the present examples are to be considered as illustrative and not restrictive, and the examples are not to be limited to the details given herein, but may be modified within the scope of the appended claims.

What is claimed is:

1. A method comprising:
obtaining a request for a first vehicle from a customer, the request including a first location;
dispatching the first vehicle to the first location, wherein dispatching the first vehicle to the first location includes causing the first vehicle to drive in an autonomous mode;
when the first vehicle arrives at the first location, providing the customer with access to enter the first vehicle; and
after providing the customer with access to enter the first vehicle, allowing the customer to manually drive the vehicle.

2. The method of claim 1 further including:
switching the first vehicle from the autonomous mode to a manual mode before allowing the customer to manually drive the vehicle.

3. The method of claim 2 further including:
initiating an authentication process with the customer before allowing the customer to manually drive the vehicle; and
determining whether the authentication process is successful, wherein switching the vehicle from the autonomous mode to the manual mode and providing the customer with access to enter the first vehicle occurs if it is determined that the authentication process is successful.

4. The method of claim 3 wherein the authentication process includes providing the customer with at least one task to perform, wherein determining whether the authentication process is successful includes determining whether the customer successfully performed the at least one task, wherein if the customer successfully performed the at least one task, the authentication process is successful.

5. The method of claim 2 further including:
determining whether a return request for the first vehicle is provided by the customer;
when it is determined that the return request for the first vehicle is provided by the customer, switching the first vehicle from the manual mode to the autonomous mode and causing the first vehicle to autonomously drive to a second location.

6. The method of claim 5 when it is determined that the return request for the first vehicle is provided by the customer, the method further includes:
identifying the second location;
identifying a current location at which the first vehicle is located; and
determining whether the first vehicle is capable of autonomously driving from the current location to the second location, wherein switching the first vehicle from the manual mode to the autonomous mode causing the first vehicle to autonomously drive to the second location occur when it is determined that the first vehicle is capable of autonomously driving from the current location to the second location.

7. The method of claim 6 wherein when it is determined that the first vehicle is not capable of autonomously driving from the current location to the second location, the method further includes:
identifying a drop-off location, wherein the first vehicle is capable of autonomously driving from the drop-off location to the second location;
determining when the first vehicle arrives at the drop-off location; and
when it is determined that the first vehicle arrives at the drop-off location, switching the first vehicle from the manual mode to the autonomous mode and causing the first vehicle to autonomously drive from the drop-off location to the second location.

8. The method of claim 7 further including allowing the customer to manually drive the vehicle from the current location to the drop-off location after identifying the drop-off location.

9. The method of claim 1 wherein the first vehicle is included in a fleet of vehicles.

10. Logic encoded in one or more tangible non-transitory, computer-readable media for execution and when executed operable to:
obtain a request for a first vehicle from a customer, the request including a first location;
dispatch the first vehicle to the first location, wherein the logic operable to dispatch the first vehicle to the first location includes logic operable to cause the first vehicle to drive in an autonomous mode;
when the first vehicle arrives at the first location, provide the customer with access to enter the first vehicle; and
after the customer is provided with access to enter the first vehicle, allow the customer to manually drive the vehicle.

11. The logic of claim 10 further operable to:
switch the first vehicle from the autonomous mode to a manual mode before allowing the customer to manually drive the vehicle.

12. The logic of claim 11 further operable to:
initiate an authentication process with the customer before allowing the customer to manually drive the vehicle; and
determine whether the authentication process is successful, wherein the logic operable to switch the vehicle from the autonomous mode to the manual mode and to provide the customer with access to enter the first vehicle is configured to switch the vehicle from the autonomous mode to the manual mode and to provide the customer with access to enter the first vehicle if it is determined that the authentication process is successful.

13. The logic of claim 12 wherein the logic operable to initiate the authentication process includes logic operable to provide the customer with at least one task to perform, wherein the logic operable to determine whether the authentication process is successful is further operable to determine whether the customer successfully performed the at least one task, and wherein if the customer successfully performed the at least one task, the authentication process is successful.

14. The logic of claim 11 further operable to:
determine whether a return request for the first vehicle is provided by the customer;
when it is determined that the return request for the first vehicle is provided by the customer, switch the first vehicle from the manual mode to the autonomous mode and causing the first vehicle to autonomously drive to a second location.

15. The method of claim 14 when it is determined that the return request for the first vehicle is provided by the customer, the logic is further operable to:
identify the second location;
identify a current location at which the first vehicle is located; and
determine whether the first vehicle is capable of autonomously driving from the current location to the second location, wherein the logic is operable to switch the first vehicle from the manual mode to the autonomous mode to cause the first vehicle to autonomously drive to the second location occur when it is determined that the first vehicle is capable of autonomously driving from the current location to the second location.

16. The logic of claim 15 wherein when it is determined that the first vehicle is not capable of autonomously driving from the current location to the second location, the logic is further operable to:
identify a drop-off location, wherein the first vehicle is capable of autonomously driving from the drop-off location to the second location;
determine when the first vehicle arrives at the drop-off location; and
when it is determined that the first vehicle arrives at the drop-off location, switch the first vehicle from the manual mode to the autonomous mode and cause the first vehicle to autonomously drive from the drop-off location to the second location.

17. A platform comprising:
a first vehicle, the first vehicle including a vehicle communications system and a switch arrangement, the vehicle communications system configured to enable the vehicle to communicate, the switch arrangement configured to enable the first vehicle to switch between an autonomous mode and a manual mode; and
a fleet management system, the fleet management system including a fleet communications arrangement configured to enable the fleet management system to communicate with the first vehicle, the fleet management system further including a control arrangement and a dispatch arrangement, the control arrangement configured to cooperate with the fleet communications system to control the switch, and to cooperate with the dispatch arrangement to cause the first vehicle to drive autonomously to a first location associated with a customer, and wherein the control arrangement cooperates with the dispatch arrangement to cause the switch arrangement to switch from the autonomous mode to the manual mode and to provide the customer with access to enter the first vehicle when the first vehicle arrives at the first location.

18. The platform of claim 17 wherein the fleet management system further includes an authentication arrangement, the authentication arrangement being configured to determine whether the customer is authenticated, and wherein when the authentication arrangement determines that the customer is authenticated, the control arrangement cooperates with the dispatch arrangement to cause the switch arrangement to switch from the autonomous mode to the manual mode and to provide the customer with the access to enter the first vehicle.

19. The platform of claim 17 wherein the fleet communications arrangement is further configured to obtain a first request from the customer, the first request being a request for the first vehicle, the first request being arranged to indicate the first location, and wherein the dispatch arrangement processes the first request.

20. The platform of claim 17 further including:
a fleet of vehicles, the fleet of vehicles including a plurality of vehicles capable of operating autonomously, the plurality of vehicles including the first vehicle, wherein while the customer is provided with access to enter the first vehicle, the switch arrangement is arranged not to switch from the manual mode to the autonomous mode.
